(19) United States
(12) Patent Application Publication
(10) Pub. No.: US 2025/0056401 A1
(43) Pub. Date: Feb. 13, 2025

(54) MECHANISM FOR SELECTING A NON-TERRESTRIAL NETWORK DEVICE

(71) Applicant: Nokia Technologies Oy, Espoo (FI)

(72) Inventors: Xiang XU, Beijing (CN); Feifei LOU, Munich (DE); Mads LAURIDSEN, Aalborg (DK); Ping YUAN, Beijing (CN)

(21) Appl. No.: 18/770,981

(22) Filed: Jul. 12, 2024

(30) Foreign Application Priority Data
Aug. 7, 2023 (WO) PCT/CN2023/111590

(51) Int. Cl. H04W 48/20; H04W 64/00; H04W 84/06

(52) U.S. Cl. CPC H04W 48/20; H04W 64/00; H04W 84/06

(57) ABSTRACT

The present disclosure relates to selecting a NTN device. In particular, a NTN device transmits information related to a set of NTN devices to a terminal device. The terminal device selects a NTN device from the set of NTN devices based on the information. The terminal device transmits data to the selected NTN device. In this way, it can avoid long latency.

### FIELDS

Various example embodiments of the present disclosure generally relate to the field of telecommunication and in particular, to methods, devices, apparatuses and computer readable storage medium for selecting a non-terrestrial network (NTN) device.

### BACKGROUND

The Third Generation Partnership Project (3GPP) has initiated a discussion on NTN for New Radio (NR) and Narrow Band Internet of Things (NB-IoT). During the discussion, the store and forward (S&F) operation has been proposed, which may allow a satellite to provide service to terminal device(s) even in periods when the satellite does not have simultaneous connection with a terminal device and with a core network (CN) device or in areas where the satellite does not have simultaneous connection with a terminal device and with a core network (CN) device.

### SUMMARY

In a first aspect of the present disclosure, there is provided an apparatus. The apparatus comprises at least one processor; and at least one memory storing instructions that, when executed by the at least one processor, cause the apparatus to: receive, from a non-terrestrial network device, information related to a set of candidate non-terrestrial network devices, wherein the information indicates at least one of: an expected time when each candidate non-terrestrial network device in the set of candidate non-terrestrial network devices connects with a corresponding candidate core network device, information associated with the candidate core network, and memory usage information of each candidate non-terrestrial network device; and transmit data to a target non-terrestrial network device that is selected from the set of candidate non-terrestrial network devices based on the information.

In a second aspect of the present disclosure, there is provided an apparatus. The apparatus comprises at least one processor; and at least one memory storing instructions that, when executed by the at least one processor, cause the apparatus to: transmit, to a terminal device, information related to a set of candidate non-terrestrial network devices, wherein the information indicates at least one of: an expected time when each candidate non-terrestrial network device connects with a corresponding core network device, information associated with the candidate core network device, memory usage information of each candidate non-terrestrial network device.

In a third aspect of the present disclosure, there is provided a method. The method comprises: receiving, from a non-terrestrial network device, information related to a set of candidate non-terrestrial network devices, wherein the information indicates at least one of: an expected time when each candidate non-terrestrial network device in the set of candidate non-terrestrial network devices connects with a corresponding candidate core network device, information associated with the candidate core network, and memory usage information of each candidate non-terrestrial network device; and transmitting data to a target non-terrestrial network device that is selected from the set of candidate non-terrestrial network devices based on the information.

In a fourth aspect of the present disclosure, there is provided a method. The method comprises: transmitting, to a terminal device, information related to a set of candidate non-terrestrial network devices, wherein the information indicates at least one of: an expected time when each candidate non-terrestrial network device connects with a corresponding core network device, information associated with the candidate core network device, memory usage information of each candidate non-terrestrial network device.

In a fifth aspect of the present disclosure, there is provided a first apparatus. The first apparatus comprises means for receiving, from a non-terrestrial network device, information related to a set of candidate non-terrestrial network devices, wherein the information indicates at least one of: an expected time when each candidate non-terrestrial network device in the set of candidate non-terrestrial network devices connects with a corresponding candidate core network device, information associated with the candidate core network, and memory usage information of each candidate non-terrestrial network device; and means for transmitting data to a target non-terrestrial network device that is selected from the set of candidate non-terrestrial network devices based on the information.

In a sixth aspect of the present disclosure, there is provided a second apparatus. The second apparatus comprises means for transmitting, to a terminal device, information related to a set of candidate non-terrestrial network devices, wherein the information indicates at least one of: an expected time when each candidate non-terrestrial network device connects with a corresponding core network device, information associated with the candidate core network device, memory usage information of each candidate non-terrestrial network device.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart of selecting a NTN device in which example embodiments of the present disclosure can be implemented;

FIG. 3 illustrates a flowchart of a method of selecting a NTN device according to some example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and one or more Distributed Unit (DU).

The term “non-terrestrial network (NTN)” used herein may refer to a network that involves non-terrestrial flying object. For example, the NTN network may include a satellite communication network, a high altitude platform system (HAPS), and/or an air-to-ground network. The term “NTN device” may refer to a network device that involves in the NTN. For example, the NTN device may be a satellite which may host a radio access network (RAN) node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As described above, the S&F operation has been proposed, which may refer to a discontinuous coverage scenario, where the UE may only occasionally and temporarily have coverage from a satellite hosting a RAN device. When the satellite's coverage includes the location of the UE, the satellite can serve the UE, for example, the UE may send a uplink (UL) data packet, which is also referred as mobile originated (MO) data, to the satellite. It is also possible that the discontinuous coverage scenario may be expanded with defining that the satellite is not always connected with the CN device. Hereinafter the RAN device may be referred to as an eNB, a gNB or any other suitable RAN devices.

The S&F architecture enables a low-cost deployment consisting of just a few satellites and a few ground stations. This means the connectivity cost per device can be further reduced at the cost of only being able to support delay tolerant data. Further, in S&F mode, the RAN device/satellite may only have the connection with CN device for a period. Similarly, the RAN device/satellite have the connection with UE for a period. The RAN device/satellite may not simultaneously have both connections, i.e., with the UE, and with the CN device. NTN Gateway (NTN-GW) is an earth station located at the surface of the earth, providing connectivity to the satellite/NTN payload using the feeder link. A NTN-GW support a RAN device on a satellite connects with core network device on the earth. Up to the deployment or configuration, a NTN-GW support a RAN device on a satellite connects with one or more core network device belonging to one operator, or more than one core network devices belonging to different operators.

Although the S&F operation is for delay-tolerant services, the services still have an upper time limit. For example, an S&F UE reports the sensor data every 12 hours. It is acceptable if the total delay is less than 12 hours, for example, 5-hour waiting for the next satellite and another 6-hour waiting for the satellite to connect with the core network on the earth via a NTN-Gateway (NTN-GW), but it is not acceptable if the total delay is more than 12 hours. The UE may be able to know how long it needs to wait for the next satellite, but the UE cannot know the total delay (delivery time). For example, the UE cannot know in advance on when the satellite will connect with a NTN-Gateway (GW) and the UE may also not know which NTN-GW the satellite will utilize (e.g. due to traffic load, weather conditions). The UE cannot know whether the NTN-GW that the satellite will connect with can support the routing to the UE's home network. It is possible that the NTN-GW deployed in Country B does not allow the satellite to forward the UL data received from UE in Country A to the CN in Country B, due to regulatory reasons, or other reasons (e.g. lack of agreement). Therefore, an efficient solution is needed to assist the UE select the most appropriate satellite to send the data.

According to some example embodiments of the present disclosure, a NTN device transmits information related to a set of NTN devices to a terminal device. The terminal device selects a NTN device from the set of NTN devices based on the information. The terminal device transmits data to the selected NTN device. In this way, it can avoid long latency.

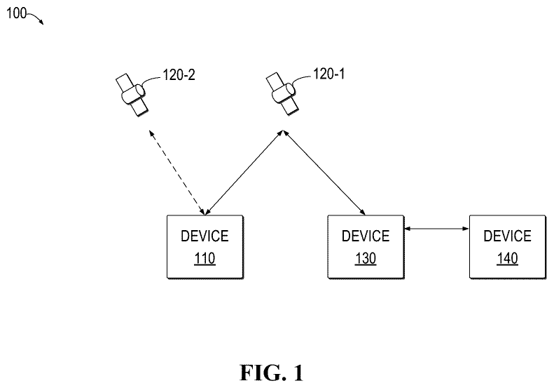

FIG. 1 shows an example communication network 100 in which embodiments of the present disclosure can be implemented. As shown in FIG. 1, the communication network 100 may comprise a terminal device 110. Hereinafter the terminal device 110 may also be referred to as a UE. The communication network 100 may further comprise a first NTN device 120-1 and a second NTN device 120-2.

In some scenarios, the first NTN device 120-1 or the second NTN device 120-2 may be hosted in satellites. In some example embodiments, the first NTN device 120-1 and the second NTN device 120-2 may as network devices in a radio access network (RAN), which may also be called as a BS, a gNB, or an eNB and can be on the satellites. The terminal device 110 may communicate with the NTN device 120-1 within a coverage of the NTN device 120-1, for example, the geographical area of the terminal device 110 is served by a satellite beam or cell from the NTN device 120-1. Later, at a different time, the terminal device 110 may communicate with the NTN device 120-2 within coverage of the NTN device 120-2, for example, the geographical area of the terminal device 110 is served by a satellite beam or cell from the NTN device 120-2.

The communication network 100 may also include a gateway 130 that acts as a router. The gateway 130 can provide a connection between the NTN device and the core network.

Furthermore, the communication network 100 may also comprise a Core Network (CN) device 140. Hereinafter the CN device 140 may also be referred to a network function in the CN, such as Access and Mobility Management Function (AMF), or Mobility Management Entity (MME), or User Plane Function (UPF), or Serving Gateway (S-GW), or PDN Gateway (P-GW), or Home Subscriber Server (HSS), etc. The terminal device 110 may communicate with the CN device 140, for example, for performing a communication of control plane signaling (e.g. a NAS procedure) or a communication of user plane packets, between the terminal device 110 and the CN device 140 via the NTN devices 120-1 and/or 120-2. The NAS procedure may be a registration procedure in 5G system, or an attach procedure in LTE system, or a service request procedure, etc. In another example, the connection or communication between the NTN device 120-1 (or 120-2) and the CN device 140 may be based on SI interface in LTE system, or Next Generation (NG) interface in 5G system, or any other control plane interface or user plane interface.

It is to be understood that the number of network devices and terminal devices shown in FIG. 1 is given for the purpose of illustration without suggesting any limitations. The communication network 100 may include any suitable number of network devices and terminal devices.

Communications in the communication environment 100 may be implemented according to any proper communication protocol(s), includes, but not limited to, cellular communication protocols of the first generation (1G), the second generation (2G), the third generation (3G), the fourth generation (4G) indicating narrow band internet of thing (NB-IoT) and enhanced machine type communication (eMTC), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

For example, in the example communication network 100 as shown in FIG. 1, the first NTN device 120-1 may not connect with terminal device 110 and CN device 140 all the time or at the same time. When the satellite moves to the geographical area of the terminal device 110, the first NTN device 120-1 may provide a cell coverage to cover the geographical area 102, the terminal device 110 may connect with the first NTN device 120-1. However, at the same time, the first NTN device 120-1 may not have the connection with the gateway 130 and the CN device 140. At a different time later (or before), the first NTN device 120-1 may connect to the gateway 130, but the first NTN device 120-1 may move out of the geographical area of the terminal device 110 and may not be able to connect with the terminal device 110. That is, possibility of UE connectivity and CN connectivity may be at different time instances.

Example embodiments of the present disclosure will be described in detail below with reference to the accompanying drawings.

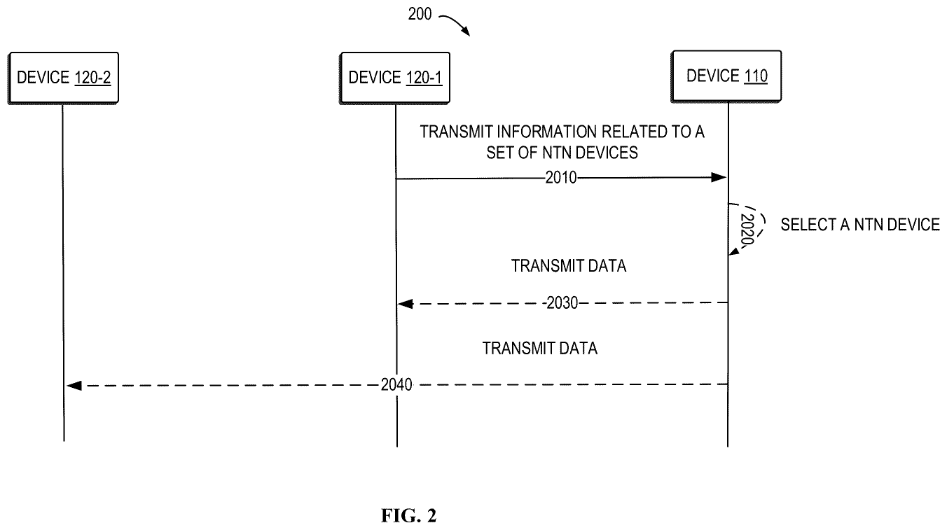

Reference is now made to FIG. 2, which shows a signaling chart 200 for communication according to some example embodiments of the present disclosure. As shown in FIG. 2, the signaling chart 200 involves the terminal device 110, the first NTN device 120-1, the second NTN device 120-2, the gateway 130 and the CN device 140. For the purpose of discussion, reference is made to FIG. 1 to describe the signaling chart 200. By way of example, the first NTN device 120-1 may be the current NTN device and the second NTN device 120-2 may be the next or subsequent NTN device. The first NTN device 120-1 may have a discontinuous connection with the terminal device 110 and the CN device 140.

The first NTN device 120-1 may provide satellite assistance information to the terminal device 110. For example, the satellite assistance information may include ephemeris information of the first NTN device 120-1 and/or other NTN device(s).

The first NTN device 120-1 transmits (2010) information regarding a set of candidate NTN devices to the terminal device 110. In other words, the terminal device 110 receives the information regarding the set of candidate NTN devices from the first NTN device 120-1. For example, the information may refer to expected payload offload information (EPOI). The set of candidate NTN devices may include any suitable number of candidate NTN devices. For example, the set of candidate NTN devices may only include the first NTN device 120-1. Alternatively, the set of candidate NTN devices may include the first NTN device 120-1 and other NTN device(s), for example, the second NTN device 120-2. In some example embodiments, the set of candidate NTN devices may not include the first NTN device 120-1. In this way, it can assist the terminal device to select a proper NTN device, thereby reducing transmission delays.

In some example embodiments, the information indicates an expected time when each candidate NTN device in the set of candidate NTN devices connects with a corresponding candidate core network device. For example, the information may indicate the expected time when the first NTN device 120-1 connects with the CN device 140 via the gateway 130. In some example embodiments, the expected time may be an absolute timing when the NTN device 120-1 connects with the CN device 140. Alternatively, the expected time may be a relative timing, for example, relative to epoch time of the satellite assistance information. In some other example embodiments, the terminal device 110 may predict the expected time based on the information. For example, the information may include location information of the gateway 130 via which the first NTN device 120-1 connects with the CN device 140. In this case, the terminal device 110 may predict the expected time based on the location information of the RAN device, and the location of the gateway.

Alternatively, or in addition, the information indicates information associated with the CN device 140. For example, in one example embodiment, a NTN-GW may only support connecting the NTN device 120-1 to certain CN devices, the information associated with the CN device may include an identity associated with the CN device 140. For example, the identity may include a public land mobile network (PLMN) identifier (ID) that identifies an operator who owns/manages the CN device 140. Alternatively, the identity associated with the CN device 140 may include a non-public network (NPN) identity, or a Stand-alone Non-Public Network (SNPN) ID including a PLMN ID and a NID. In some other example embodiments, the identity associated with the CN device 140 may include an identity of an access and mobility management function (AMF). In another example embodiment, if a NTN-GW (for example, the device 130) supports connecting the NTN device 120-1 to any CN devices, the information associated with the CN device may have a special value (for example, “ALL”) indicating the support of all CN device. In yet another example embodiment, when a NTN-GW supports connecting the NTN device 120-1 to any CN devices, the information associated with the CN device may be absent and not include the identity associated with the CN device 140, which implicitly means the related NTN device may be able to connect with any CN device via the NTN-GW. The information may also indicate a usage information, for example, a memory usage information of each candidate NTN in the set of candidate NTN devices. For example, the usage information or memory usage information may include information related to load of the cell or an amount of payload which the cell is already carrying. The term “identity associated with a core network” and the term “identity associated with a core network device” can be used interchangeable.

For example, as indicated above, the information may be related to a plurality of candidate NTN devices. In this case, for each candidate NTN device in the set of candidate NTN devices, the information indicates an expected time when the candidate NTN device connects with a corresponding CN device, information associated with the CN device and its memory usage information. In other words, the information may include information associated with the CN device that can be supported by the set of candidate NTN devices, a plurality of expected time when the set of NTN devices connects with the corresponding CN device, memory usage information regarding the set of candidate NTN devices. By way of example, the information may indicate a further expected time when the second NTN device 120-2 connects with a further CN device and information associated with the further CN device.

In some example embodiments, the information may be transmitted (2010) in a dedicated radio resource control (RRC) signaling. For example, the information may be provided during a RRC establishment. In some other example embodiments, the information may be transmitted (2010) in system information. For example, the information may be provided as part of a system information block (SIB) 32. The SIB32 may be dedicated to discontinuous coverage and can provide satellite assistance information for up to 4 upcoming satellites. Table 1 below shows an example information element (IE) of the information where the information (e.g. named as EPOI IE) includes a dataOffloadTime indicating the expected time when the satellite connects with a CN device, a list of supportedPLMNs associated with the CN device that the satellite connects with, and a memory usage indication. It is noted that Table 1 is only an example not limitation.

TABLE 1

```
-- ASN1START
SystemInformationBlockType32-r17 ::= SEQUENCE {
    satelliteInfoList-r17 SatelliteInfoList-r17 OPTIONAL, --
Need OR
    lateNonCriticalExtension OCTET STRING OPTIONAL,
    . . .
}
SatelliteInfoList-r17 ::= SEQUENCE (SIZE (1..maxSat-r17) ) OF
SatelliteInfo-r17
SatelliteInfo-r17 ::= SEQUENCE {
    satelliteId-r17 INTEGER (0..255),
    EPOI SEQUENCE {
        dataOffloadTime TimeOffsetUTC-r17
        supportedPLMNs PLMN-IdentityList
        memoryusage MemoryUsage
        },
    serviceInfo-r17 SEQUENCE {
        tle-EphemerisParameters-r17 TLE-Ephemeris Parameters-r17 OPTIONAL,
    -- Need OR
        t-ServiceStart-r17 TimeOffsetUTC-r17 OPTIONAL
    -- Need OR
        },
    footprintInfo-r17 SEQUENCE {
        referencePoint-r17 SEQUENCE {
            longitude-r17 INTEGER (−131072..131071),
            latitude-r17 INTEGER (−131072..131071)
        } OPTIONAL, -- Need OR
        elevationAngles-r17 SEQUENCE {
                elevationAngleRight-r17 INTEGER (−14..14),
                elevationAngleLeft-r17 INTEGER (−14..14) OPTIONAL --
Need OP
        } OPTIONAL, -- Need OR
        radius-r17 INTEGER (1..256) OPTIONAL
    -- Need OR
    }
}
-- ASN1STOP
```

The terminal device 110 may select (2020) a NTN device to transmit its data based on the information. For example, the terminal device 110 may determine a subset of candidate non-terrestrial network devices from the set of candidate non-terrestrial network devices. In this case, each one in the subset of candidate non-terrestrial network devices connects to a target core network device that is associated with information supporting an identity selected by the terminal device 110. In some example embodiments, the identity selected by the terminal device 110 may be a PLMN identity. Alternatively, identity selected by the terminal device 110 may be a NPN identity or SNPN ID. In some other example embodiments, the identity selected by the terminal device 110 may be an identity of AMF. In another example embodiment, the information may not include any identity associated with the CN device that a candidate non-terrestrial network device connect with. This means the candidate NTN device can connect with any CN device, which implicitly means that the candidate NTN device can support the identity selected by the terminal device 110. The terminal device 110 may then determine total transmission delays for each candidate non-terrestrial network device in the subset of candidate non-terrestrial network devices. The terminal device 110 may select a candidate non-terrestrial network device with a shortest total transmission delay in the subset of candidate non-terrestrial network devices to be the target non-terrestrial network device.

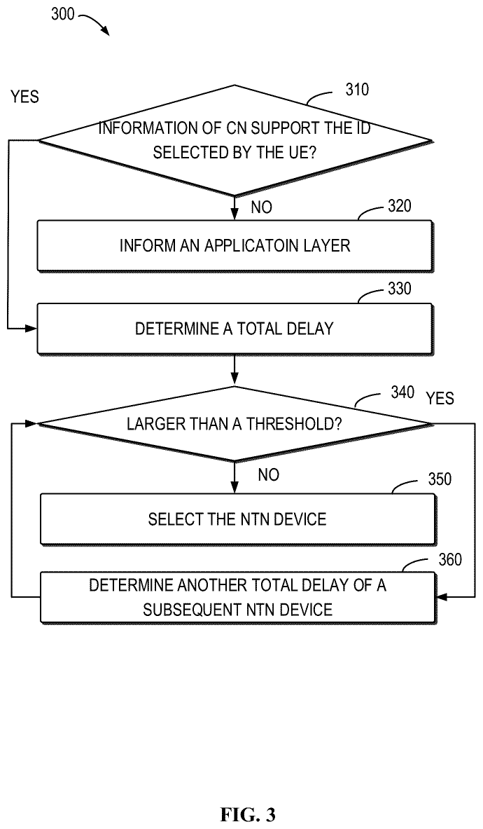

FIG. 3 illustrates a flow chart of a method 300 for selecting the NTN device according to example embodiments of the present disclosure.

At block 310, the terminal device 110 may check the information associated with the CN device for each satellite. In one example embodiment, the information associated with the CN device includes one or more identities associated with the CN device or has a special value (for example, “ALL”) indicating the support of any/all CN devices. For example, if a NTN-GW may support connecting the NTN device 120-1 to any CN devices, the information associated with the CN device may have a special value (for example, “ALL”) indicating the support of all CN device. In another example embodiment, the information associated with the CN device is absent, which implicitly means the NTN device may connect with any CN device. For example, the terminal device 110 may determine whether the identity associated with the CN device that the first NTN device 120-1 connects with matches with an identity the terminal device 110. In other words, the terminal device 110 may determine whether an operator of the CN device that the satellite will connect with is the one selected by the terminal device 110 which is identified by the PLMN of the terminal device 110. The terminal device 110 may further determine whether the further identity (i.e., PLMN) associated with a further CN that the second NTN device 120-2 connects with matches with the PLMN of the terminal device 110. In another example embodiment, the information associated with the CN device have a special value (for example, “ALL”) indicating the support of any CN device, the terminal device 110 may determine an operator of the CN device that the satellite will connect with is the one selected by the terminal device 110 which is identified by the PLMN of the terminal device 110. In yet another example, when the information associated with the CN device for a NTN device/satellite is absent, which implicitly means the NTN device can connect with any CN device, the terminal device 110 determines the NTN device can connect with any CN device and support the PLMN ID selected by the terminal device 110.

If the IDs associated with the CN device(s) in the information do not include the PLMN ID of the terminal device 110, at block 320, the terminal device 110 may inform an application layer that the information does not include the PLMN ID of the terminal device 110. For example, the application layer may decide whether select the NTN device. In one example embodiment, the terminal device 110 may select the NTN device to transmit the UL data/signaling.

If the information associated with the CN device(s) support the identity selected by the terminal device 110, for example, the information associated with the CN device that the NTN device connect with is present and the IDs associated with the CN device(s) in the information include the PLMN ID of the terminal device 110, or the information associated with the CN device that the NTN device connect with has a special value (for example “ALL”), or the information associated with the CN device that the NTN device connect with is absent which implicitly means the CN device supports the PLMN ID of the terminal device 110, the terminal device 110 may determine a total transmission delay at block 330. For example, if the identity associated with the CN device 140 that the first NTN device 120-1 connects with matches with the PLMN of the terminal device 110, the terminal device 110 may determine the total transmission delay between the terminal device 110 and the CN device 140 based on the expected time when the first NTN device 120-1 connects with the CN device 140, and the time the terminal device 110 can transmit the payload to the first NTN device 120-1. In other words, the total transmission delay includes a delay where the terminal device waits for the NTN device and a delay where the NTN device waits for connection with the core network.

At block 340, the terminal device 110 may determine whether the determined total transmission delay is larger than a delay threshold. For example, the delay threshold may be an upper time limit. The upper time limit may refer to a maximum time duration that the transmission of the data can be postponed. The terminal device 110 may determine whether the total transmission delay between the terminal device 110 and the CN device 140 is larger than the delay threshold.

If the determined total transmission delay is not larger than the delay threshold, at block 350, the terminal device 110 may select the NTN device. For example, if the total transmission delay between the terminal device 110 and the CN device 140 is not larger than the delay threshold, the terminal device 110 may select the first NTN device 120-1 to transmit its data.

If the determined total transmission delay is larger than the delay threshold, at block 360, the terminal device 110 may determine another total transmission delay for another NTN device. For example, the terminal device 110 may determine a further total transmission delay between the terminal device 110 and a further CN device associated with the NTN 120-2 device based on the further expected time when the second NTN device 120-2 connects with the further CN device, and when the second NTN device 120-2 serves the terminal device 110. The terminal device 110 may go back to block 340 to determine whether the further total transmission delay between the terminal device 110 and the CN device 140 is larger than the delay threshold or not. In this case, if the further total transmission delay between the terminal device 110 and the CN device 140 is not larger than the delay threshold, the terminal device 110 may select the second NTN device 120-2 to transmit its data.

In some example embodiments, if the total transmission delays for all NTN devices are larger than the delay threshold, the terminal device 110 may provide an indication to the application layer and let the application layer decide whether select the NTN device. Alternatively, the terminal device 110 may select the NTN device.

An example embodiment is described in detailed for the purpose of illustrations. The first NTN device 120-1 that is the current NTN device may serve geo-area #A between 7:00-7:10. The first NTN device 120-1 may provide following information to the terminal device 110 via SIB or dedicated RRC: for the current NTN device (i.e., the first NTN device 120-1), the first NTN device 120-1 will connect with NTN-GW11/CN device at 20:00, the ID associated with the CN device that the NTN-GW11 can connect with is PLMN #1, and the first NTN device 120-1 will connect with NTN-GW12/CN device at 21:00, the ID associated with the CN device that the NTN-GW12 can connect with is PLMN #3; for the next satellite (for example, the second NTN device 120-2), the second NTN device 120-2 will serve geo-area #A at 11:00-11:10, the second NTN device 120-2 will connect with NTN-GW21/CN device at 15:00, the ID associated with the CN device that the NTN-GW21 can connect with is PLMN #1, the second NTN device 120-2 will connect with NTN-GW22/CN device at 8:00 (next day), the ID associated with the CN device that the NTN-GW22 can connect with is PLMN #3. In geo-area #A, there may be a terminal device 110 (PLMN #1) and another terminal device (not shown in FIG. 1). When the first NTN device 120-1 serves the area during 7:00-7:10, the terminal device 110 and the other terminal device may determine which NTN device is to be used for mobile originated (MO) data. The terminal device 110 has an upper time limit 12-hour: By checking the ID associated with the CN device, the terminal device 110 finds both the first NTN device 120-1+NTN-GW11, and the second NTN device 120-2+NTN-GW21 can be used. The total delay for using the first NTN device 120-1+NTN-GW11 is 13-hour (e.g., the terminal device 110 sends MO data at 7:00, then the MO data is forwarded to CN at 20:00). The total delay for using second NTN device 120-2+NTN-GW21 is 8-hour (e.g., the terminal device 110 waits 4 hours for second NTN device 120-2, the terminal device 110 sends MO data at 11:00, then the MO data is forwarded to CN at 15:00). Thus, the terminal device 110 selects second NTN device 120-2 for MO (e.g., the terminal device 110 skips the first NTN device 120-1 after it makes the decision but the terminal device 110 may still monitor for paging from the first NTN device 120-1). The other terminal device hashes an upper time limit 24-hour: By checking the ID associated with the CN device, the other terminal device finds both the first NTN device 120-1+NTN-GW12, and second NTN device 120-2+NTN-GW22 can be used. The total delay for using the first NTN device 120-1+NTN-GW12 is 14-hour (e.g., the other terminal device sends MO data at 7:00, then the MO data is forwarded to CN at 21:00). The total delay for using second NTN device 120-2+NTN-GW22 is 25-hour (e.g., the other terminal device waits 4 hours for SAT2, the other terminal device sends MO data at 11:00, then the MO data is forwarded to CN at 8:00 next day). Thus, the other terminal device selects the first NTN device 120-1 for MO.

Referring back to FIG. 2, if the first NTN device 120-1 is the selected NTN device, the terminal device 110 may transmit (2030) the data to the first NTN device 120-1. Later, the first NTN device 120-1 may forward the data to the CN device 140 via the gateway 130. Alternatively, if the second NTN device 120-2 is the selected NTN device, the terminal device 110 may transmit (2040) the data to the second NTN device 120-2. Later, the second NTN device 120-2 may forward the data to the CN device 140 via the gateway 130. It is to be understood that the NTN devices may use different gateways.

In an example embodiment, the first NTN device 120-1 may be the selected NTN device while the total transmission delay between the first NTN device 120-1 and the CN device 140 is larger than the delay threshold. In this case, the terminal device 110 may transmit the data and the delay threshold to the first NTN device 120-1. Alternatively, the terminal device 110 may only transmit the delay threshold to the first NTN deuce 120-1 to indicate the delay issue. In this case, the first NTN device 120-1 may further forward the received data, the delay threshold, and the actual delay, to the CN device 140 via the gateway 130. The Operator or CN may take further actions, e.g. adding more satellite, or adjust the charging rate, and the like.

In some example embodiments, there may be a plurality of NTN devices that fulfil the above condition. In this case, the terminal device 110 may select the NTN device for transmitting the data from the plurality of NTN devices based on some other information. For example, if the terminal device 110 determines that the first NTN device 120-1 is with less memory usage, the terminal device 110 may select the first NTN device 120-1. In this way, it can avoid highly load at a specific NTN device.

Alternatively, the plurality of NTN devices (for example, the first NTN device 120-1 and the second NTN device 120-2) may provide link budget information to the terminal device 110, respectively. For example, the terminal device 110 may determine the link budget information based on the ephemeris provided by the plurality of NTN devices. In this case, the terminal device 110 may select the NTN device which is expected to have the best link budget (such as, based on the shortest distance between the NTN device and the terminal device 110) or postpone transmission to the NTN device appearing latest, but within the time limit, to allow for transmission of additional data in one combined packet (if such additional data is expected to appear).

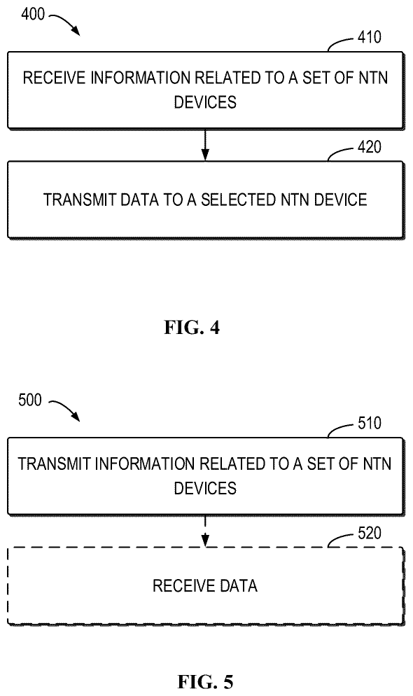

FIG. 4 shows a flowchart of an example method 400 implemented at an apparatus in accordance with some example embodiments of the present disclosure. For the purpose of discussion, the method 400 will be described from the perspective of the terminal device 110 in FIG. 1.

At block 410, the terminal device 110 receives, from a non-terrestrial network device, information related to a set of candidate non-terrestrial network devices, wherein the information indicates at least one of: an expected time when each candidate non-terrestrial network device in the set of candidate non-terrestrial network devices connects with a corresponding candidate core network device, information associated with the candidate core network device, and memory usage information of each candidate non-terrestrial network device.

At block 420, the terminal device 110 transmits data to a target non-terrestrial network device that is selected from the set of candidate non-terrestrial network devices based on the information.

In some example embodiments, the method 400 further comprises: determining whether information associated with a core network device with which the non-terrestrial network device connects indicated in the information supports an identity selected by the apparatus.

In some example embodiments, the method 400 further comprises: in accordance with a determination that an identity associated with the core network device indicated in the information associated with the core network device matches with the identity selected by the apparatus, determining a total transmission delay between the apparatus and the core network device based on when the non-terrestrial network device serves the apparatus and the expected time when the non-terrestrial network device connects with the core network device; and determining whether the total transmission delay is larger than a delay threshold.

In some example embodiments, the method 400 further comprises: in accordance with a determination that the total transmission delay is not larger than the delay threshold, determining the non-terrestrial network device to be the target non-terrestrial network device; and transmitting the data to the non-terrestrial network device.

In some example embodiments, the method 400 further comprises: determining a subset of candidate non-terrestrial network devices from the set of candidate non-terrestrial network devices, wherein each one in the subset of candidate non-terrestrial network devices connects to a target core network device that is associated with information supporting an identity selected by the apparatus; determining total transmission delays for each candidate non-terrestrial network device in the subset of candidate non-terrestrial network devices; and selecting a candidate non-terrestrial network device with a shortest total transmission delay in the subset of candidate non-terrestrial network devices to be the target non-terrestrial network device.

In some example embodiments, the set of candidate non-terrestrial network devices also includes a further non-terrestrial network device, and the information further indicates a further expected time when the further non-terrestrial network device connects with a further core network device and information associated with a further core network.

In some example embodiments, the method 400 further comprises: determining whether the information associated with the further core network device supports the identity selected by the apparatus.

In some example embodiments, the method 400 further comprises: in accordance with a determination that a further identity associated with the further core network device indicated in the information associated with the further core network device matches with the identity selected by the apparatus, determining a further total transmission delay between the apparatus and the further core network device based on when the further non-terrestrial network device serves the apparatus, and the further expected time when the further non-terrestrial network device connects with the further core network device; and determining whether the further total transmission delay is larger than the delay threshold.

In some example embodiments, the method 400 further comprises: in accordance with a determination that the total transmission delay is larger than the delay threshold and the further total transmission delay is not larger than the delay threshold, determining the further non-terrestrial network device as the target non-terrestrial network device; and transmitting the data to the further non-terrestrial network device.

In some example embodiments, the method 400 further comprises: in accordance with a determination that both the total transmission delay and the further total transmission delay are not larger than the delay threshold, selecting the non-terrestrial network device or the further non-terrestrial network device for transmitting the data based on at least one of: memory usage information of the non-terrestrial network device and the further non-terrestrial network device, or linking budget information of the non-terrestrial network device and the further non-terrestrial network device.

In some example embodiments, the method 400 further comprises: in accordance with a determination to transmit the data to the non-terrestrial network device or the further non-terrestrial network device, transmitting the data and the delay threshold to the selected non-terrestrial network device; or transmitting the delay threshold to the selected non-terrestrial network device.

In some example embodiments, the method 400 further comprises: in accordance with a determination that both the total transmission delay and the further total transmission delay are larger than the delay threshold, providing, to an application layer of the apparatus an indication, to select the non-terrestrial network device or the further non-terrestrial network device for transmitting the data; or selecting the non-terrestrial network device or the further non-terrestrial network device for transmitting the data based on the total transmission delay and the further total transmission delay.

In some example embodiments, the information comprises one of: an absolute timing of the expected time, a relative timing of the expected time, or a location information to determine the expected time.

In some example embodiments, the apparatus is a terminal device, and wherein the non-terrestrial network device has a discontinuous connection with the apparatus and its corresponding core network device.

FIG. 5 shows a flowchart of an example method 500 implemented at a second device in accordance with some example embodiments of the present disclosure. For the purpose of discussion, the method 500 will be described from the perspective of the first NTN device 120-1 in FIG. 1.

At block 510, the first NTN device 120-1 transmits, to a terminal device 110, information related to a set of candidate non-terrestrial network devices. The information indicates at least one of: an expected time when each candidate non-terrestrial network device connects with a corresponding candidate core network device, information associated with the candidate core network device, memory usage information of each candidate non-terrestrial network device.

In some example embodiments, the set of candidate non-terrestrial network devices also includes a further non-terrestrial network device, and the information further indicates a further expected time when the further non-terrestrial network device connects with a further core network device and information associated with the further core network device.

In some example embodiments, the method 500 further comprises: transmitting, to the terminal device, at least one of the followings: linking budget information of the non-terrestrial network device and the further non-terrestrial network device.

In some example embodiments, the method 500 further comprises: receiving data from the terminal device; and forward the data to the core network.

In some example embodiments, at block 520, the first NTN device 120-1 receives data from the terminal device. The first NTN device 120-1 may forward the data to the core network via the radio access network device.

In some example embodiments, the method 500 further comprises: receiving data and a delay threshold for data transmission from the terminal device; and forward the data and the delay threshold to the core network via the radio access network device.

In some example embodiments, the first NTN device 120-1 may have a discontinuous connection with the terminal device and the core network device.

In some example embodiments, a first apparatus capable of performing any of the method 400 (for example, the terminal device 110 in FIG. 1) may comprise means for performing the respective operations of the method 400. The means may be implemented in any suitable form. For example, the means may be implemented in a circuitry or software module. The first apparatus may be implemented as or included in the terminal device 110 in FIG. 1.

In some example embodiments, the first apparatus comprises means for receiving, from a non-terrestrial network device, information related to a set of candidate non-terrestrial network devices, wherein the information indicates at least one of: an expected time when each candidate non-terrestrial network device in the set of candidate non-terrestrial network devices connects with a corresponding candidate core network device, information associated with the candidate core network, and memory usage information of each candidate non-terrestrial network device; and means for transmitting data to a target non-terrestrial network device that is selected from the set of candidate non-terrestrial network devices based on the information.

In some example embodiments, the first apparatus further comprises: means for determining whether information associated with a core network device with which the non-terrestrial network device connects indicated in the information supports an identity selected by the apparatus.

In some example embodiments, the first apparatus further comprises: means for in accordance with a determination that an identity associated with the core network device indicated in the information associated with the core network device matches with the identity selected by the apparatus determining a total transmission delay between the apparatus and the core network device based on when the non-terrestrial network device serves the apparatus and the expected time when the non-terrestrial network device connects with the core network device; and means for determining whether the total transmission delay is larger than a delay threshold.

In some example embodiments, the first apparatus further comprises: means for in accordance with a determination that the total transmission delay is not larger than the delay threshold, determining the non-terrestrial network device to be the target non-terrestrial network device; and means for transmitting the data to the non-terrestrial network device.

In some example embodiments, the first apparatus further comprises: means for determining a subset of candidate non-terrestrial network devices from the set of candidate non-terrestrial network devices, wherein each one in the subset of candidate non-terrestrial network devices connects to a target core network device that is associated with information supporting an identity selected by the apparatus; means for determining total transmission delays for each candidate non-terrestrial network device in the subset of candidate non-terrestrial network devices; and means for selecting a candidate non-terrestrial network device with a shortest total transmission delay in the subset of candidate non-terrestrial network devices to be the target non-terrestrial network device.

In some example embodiments, the set of candidate non-terrestrial network devices also includes a further non-terrestrial network device, and the information further indicates a further expected time when the further non-terrestrial network device connects with a further core network device and information associated with a further core network.

In some example embodiments, the first apparatus further comprises: means for determining whether the information associated with the further core network device supports the identity selected by the apparatus.

In some example embodiments, the first apparatus further comprises: means for in accordance with a determination that a further identity associated with the further core network device indicated in the information associated with the further core network device matches with the identity selected by the apparatus, determining a further total transmission delay between the apparatus and the further core network device based on when the further non-terrestrial network device serves the apparatus, and the further expected time when the further non-terrestrial network device connects with the further core network device; and means for determining whether the further total transmission delay is larger than the delay threshold.

In some example embodiments, the first apparatus further comprises: means for in accordance with a determination that the total transmission delay is larger than the delay threshold and the further total transmission delay is not larger than the delay threshold, determining the further non-terrestrial network device as the target non-terrestrial network device; and means for transmitting the data to the further non-terrestrial network device.

In some example embodiments, the first apparatus further comprises: means for in accordance with a determination that both the total transmission delay and the further total transmission delay are not larger than the delay threshold, selecting the non-terrestrial network device or the further non-terrestrial network device for transmitting the data based on at least one of: memory usage information of the non-terrestrial network device and the further non-terrestrial network device, or means for linking budget information of the non-terrestrial network device and the further non-terrestrial network device.

In some example embodiments, the first apparatus further comprises: in accordance with a determination to transmit the data to the non-terrestrial network device or the further non-terrestrial network device, means for transmitting the data and the delay threshold to the selected non-terrestrial network device; or means for transmitting the delay threshold to the selected non-terrestrial network device.

In some example embodiments, the first apparatus further comprises: in accordance with a determination that both the total transmission delay and the further total transmission delay are larger than the delay threshold, means for providing, to an application layer of the apparatus an indication, to select the non-terrestrial network device or the further non-terrestrial network device for transmitting the data; or means for selecting the non-terrestrial network device or the further non-terrestrial network device for transmitting the data based on the total transmission delay and the further total transmission delay.

In some example embodiments, the information comprises one of: an absolute timing of the expected time, a relative timing of the expected time, or a location information to determine the expected time.

In some example embodiments, the apparatus is a terminal device, and wherein the non-terrestrial network device has a discontinuous connection with the apparatus and its corresponding core network device.

In some example embodiments, the first apparatus further comprises means for performing other operations in some example embodiments of the method 400 or the terminal device 110. In some example embodiments, the means comprises at least one processor; and at least one memory storing instructions that, when executed by the at least one processor, cause the performance of the first apparatus.

In some example embodiments, a second apparatus capable of performing any of the method 500 (for example, the first NTN device 120-1 in FIG. 1) may comprise means for performing the respective operations of the method 500. The means may be implemented in any suitable form. For example, the means may be implemented in a circuitry or software module. The second apparatus may be implemented as or included in the first NTN device 120-1 in FIG. 1.

In some example embodiments, the second apparatus comprises means for transmitting, to a terminal device, information related to a set of candidate non-terrestrial network devices, wherein the information indicates at least one of: an expected time when each candidate non-terrestrial network device connects with a corresponding core network device, information associated with the candidate core network device, memory usage information of each candidate non-terrestrial network device.

In some example embodiments, the set of candidate non-terrestrial network devices also includes a further non-terrestrial network device, and the information further indicates a further expected time when the further non-terrestrial network device connects with a further core network device and information associated with the further core network device.

In some example embodiments, the second apparatus further comprises: means for transmitting, to the terminal device, at least one of the followings: means for linking budget information of the non-terrestrial network device and the further non-terrestrial network device.

In some example embodiments, the second apparatus further comprises: means for receiving data from the terminal device; and forward the data to the core network.

In some example embodiments, the second apparatus further comprises: means for receiving data and a delay threshold for data transmission from the terminal device; and forward the data and the delay threshold to the core network device.

In some example embodiments, the apparatus comprises a non-terrestrial network device that has a discontinuous connection with the terminal device and the core network device.

In some example embodiments, the second apparatus further comprises means for performing other operations in some example embodiments of the method 500 or the first NTN device 120-1. In some example embodiments, the means comprises at least one processor; and at least one memory storing instructions that, when executed by the at least one processor, cause the performance of the second apparatus.

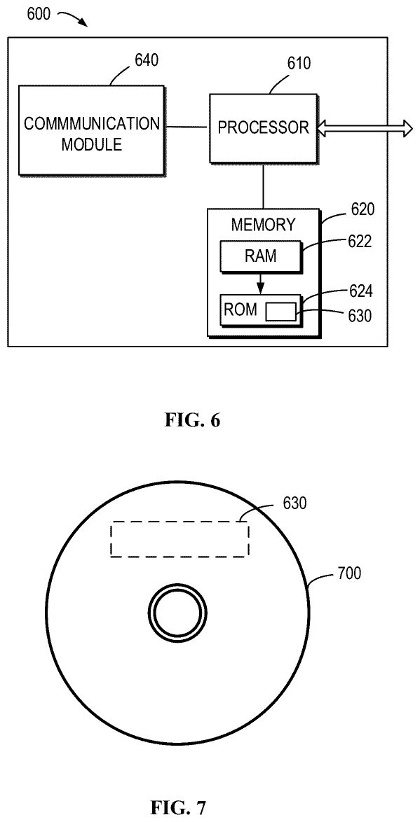

FIG. 6 is a simplified block diagram of a device 600 that is suitable for implementing example embodiments of the present disclosure. The device 600 may be provided to implement a communication device, for example, the terminal device 110 or the first NTN device 120-1 or the second NTN device 120-2 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus to:
receive, from a non-terrestrial network device, information related to a set of candidate non-terrestrial network devices, wherein the information indicates at least one of: an expected time when each candidate non-terrestrial network device in the set of candidate non-terrestrial network devices connects with a corresponding candidate core network device, information associated with the candidate core network device, and memory usage information of each candidate non-terrestrial network device; and
transmit data to a target non-terrestrial network device that is selected from the set of candidate non-terrestrial network devices based on the information.

2. The apparatus of claim 1, wherein the apparatus is caused to:
determine whether information associated with a core network device with which the non-terrestrial network device connects indicated in the information supports an identity selected by the apparatus.

3. The apparatus of claim 2, wherein the apparatus is caused to:
in accordance with a determination that an identity associated with the core network device indicated in the information associated with the core network device matches with the identity selected by the apparatus,
determine a total transmission delay between the apparatus and the core network device based on when the non-terrestrial network device serves the apparatus and the expected time when the non-terrestrial network device connects with the core network device; and
determine whether the total transmission delay is larger than a delay threshold.

4. The apparatus of claim 3, wherein the apparatus is caused to:
in accordance with a determination that the total transmission delay is not larger than the delay threshold, determine the non-terrestrial network device to be the target non-terrestrial network device; and
transmit the data to the non-terrestrial network device.

5. The apparatus of claim 1, wherein the apparatus is caused to:
determine a subset of candidate non-terrestrial network devices from the set of candidate non-terrestrial network devices, wherein each one in the subset of candidate non-terrestrial network devices connects to a target core network device that is associated with information supporting an identity selected by the apparatus;
determine total transmission delays for each candidate non-terrestrial network device in the subset of candidate non-terrestrial network devices; and
select a candidate non-terrestrial network device with a shortest total transmission delay in the subset of candidate non-terrestrial network devices to be the target non-terrestrial network device.

6. The apparatus of claim 1, wherein the set of candidate non-terrestrial network devices also includes a further non-terrestrial network device, and the information further indicates at least one of: a further expected time when the further non-terrestrial network device connects with a further core network device and information associated with the further core network device.

7. The apparatus of claim 6, wherein the apparatus is caused to:
determine whether the information associated with the further core network device supports the identity selected by the apparatus.

8. The apparatus of claim 7, wherein the apparatus is caused to:
in accordance with a determination that a further identity associated with the further core network device indicated in the information associated with the further core network device matches with the identity selected by the apparatus,
determine a further total transmission delay between the apparatus and the further core network device based on when the further non-terrestrial network device serves the apparatus, and the further expected time when the further non-terrestrial network device connects with the further core network device; and
determine whether the further total transmission delay is larger than the delay threshold.

9. The apparatus of claim 8, wherein the apparatus is caused to:
in accordance with a determination that the total transmission delay is larger than the delay threshold and the further total transmission delay is not larger than the delay threshold, determine the further non-terrestrial network device as the target non-terrestrial network device; and
transmit the data to the further non-terrestrial network device.

10. The apparatus of claim 8, wherein the apparatus is caused to:
in accordance with a determination that both the total transmission delay and the further total transmission delay are not larger than the delay threshold, select the non-terrestrial network device or the further non-terrestrial network device for transmitting the data based on at least one of:
memory usage information of the non-terrestrial network device and the further non-terrestrial network device, or
link budget information of the non-terrestrial network device and the further non-terrestrial network device.

11. The apparatus of claim 9, wherein the apparatus is caused to:
in accordance with a determination to transmit the data to the non-terrestrial network device or the further non-terrestrial network device,
transmit the data and the delay threshold to the selected non-terrestrial network device; or
transmit the delay threshold to the selected non-terrestrial network device.

12. The apparatus of claim 11, wherein the apparatus is caused to:
in accordance with a determination that both the total transmission delay and the further total transmission delay are larger than the delay threshold,
provide, to an application layer of the apparatus an indication, to select the non-terrestrial network device or the further non-terrestrial network device for transmitting the data; or
select the non-terrestrial network device or the further non-terrestrial network device for transmitting the data based on the total transmission delay and the further total transmission delay.

13. The apparatus of claim 1, wherein the information comprises one of:
an absolute timing of the expected time,
a relative timing of the expected time, or
a location information to determine the expected time.

14. The apparatus of claim 1, wherein the apparatus is a terminal device, and
wherein the non-terrestrial network device has a discontinuous connection with the apparatus and its corresponding core network device.

15. An apparatus comprising:
at least one processor; and
at least one memory storing instructions that, when executed by the at least one processor, cause the apparatus to:
transmit, to a terminal device, information related to a set of candidate non-terrestrial network devices, wherein the information indicates at least one of: an expected time when each candidate non-terrestrial network device connects with a corresponding candidate core network device, information associated with the candidate core network device, memory usage information of each candidate non-terrestrial network device.

16. The apparatus of claim 15, wherein the set of candidate non-terrestrial network devices also includes a further non-terrestrial network device, and the information further indicates at least one of: a further expected time when the further non-terrestrial network device connects with a further core network device and information associated with the further core network device.

17. The apparatus of claim 15, wherein the apparatus is caused to:
transmit, to the terminal device, at least one of the followings:
link budget information of the non-terrestrial network device and the further non-terrestrial network device.

18. The apparatus of claim 15, wherein the apparatus is caused to:
receive data from the terminal device; and
forward the data to the core network device.

19. The apparatus of claim 15, wherein the apparatus is caused to:
receive data and a delay threshold for data transmission from the terminal device; and
forward the data and the delay threshold to the core network device.

20. The apparatus of claim 15, wherein the apparatus comprises a non-terrestrial network device that has a discontinuous connection with the terminal device and the core network device.

21. A method comprising:
receiving, at an apparatus and from a non-terrestrial network device, information related to a set of candidate non-terrestrial network devices, wherein the information indicates at least one of: an expected time when each candidate non-terrestrial network device in the set of candidate non-terrestrial network devices connects with a corresponding candidate core network device, information associated with the candidate core network device, and memory usage information of each candidate non-terrestrial network device; and
transmitting data to a target non-terrestrial network device that is selected from the set of candidate non-terrestrial network devices based on the information.

22. A method comprising:
transmitting, at an apparatus and to a terminal device, information related to a set of candidate non-terrestrial network devices, wherein the information indicates at least one of: an expected time when each candidate non-terrestrial network device connects with a corresponding candidate core network device, information associated with the candidate core network device, memory usage information of each candidate non-terrestrial network device.
